(19) United States
(12) Patent Application Publication
(10) Pub. No.: US 2011/0080019 A1
(43) Pub. Date: Apr. 7, 2011

(54) AERODYNAMIC VEHICLES AND FAIRING ASSEMBLIES THEREOF

(75) Inventor: Brian V. Castillo, Royal Oak, MI (US)

(73) Assignee: GM GLOBAL TECHNOLOGY OPERATIONS, INC., Detroit, MI (US)

(21) Appl. No.: 12/574,762

(22) Filed: Oct. 7, 2009

(51) Int. Cl. B62D 37/02

(52) U.S. Cl. 296/180.1

(57) ABSTRACT

A vehicle having reduced aerodynamic drag includes a wheel assembly configured for moving the vehicle across a surface. The wheel assembly has an inboard surface and an outboard surface and includes a wheel configured for rotation with respect to the vehicle and a tire disposed on the wheel. The vehicle also includes a fairing assembly configured for reducing aerodynamic drag across the wheel assembly. The fairing assembly includes a first portion configured for partially enclosing an inboard surface of the wheel assembly and a second portion configured for partially enclosing an outboard surface of the wheel assembly and removably coupled to the first portion. The fairing assembly is moveable in unison with the wheel assembly during vehicle steering and suspension maneuvers.

### TECHNICAL FIELD

The present invention generally relates to aerodynamic vehicles and wheel covers thereof, and more specifically, to fairing assemblies configured for reducing aerodynamic drag across a vehicle wheel assembly.

### BACKGROUND OF THE INVENTION

Vehicles having excellent fuel efficiency provide both economical and environmentally-friendly transportation for people and freight, and are therefore, increasingly desirable. One way to improve vehicle fuel efficiency is to reduce an aerodynamic drag of the vehicle. In particular, aerodynamic drag may be reduced by improving air flow across the vehicle.

### SUMMARY OF THE INVENTION

A vehicle having reduced aerodynamic drag includes a wheel assembly configured for moving the vehicle across a surface, e.g., a road. The wheel assembly has an inboard surface and an outboard surface and includes a wheel configured for rotation with respect to the vehicle, and a tire disposed on the wheel. The vehicle also includes a fairing assembly configured for reducing aerodynamic drag across the wheel assembly. The fairing assembly includes a first portion configured for partially enclosing the inboard surface of the wheel assembly and a second portion configured for partially enclosing an outboard surface of the wheel assembly. The second portion is removably coupled to the first portion. The fairing assembly is moveable in unison with the wheel assembly during vehicle steering and suspension maneuvers.

In another variation, the vehicle further includes a side body panel and a fascia spaced apart from the side body panel to define a wheelhouse that is configured for housing the wheel assembly. Additionally, the vehicle includes a vehicle control system attached to the wheel and partially disposed within the wheelhouse. The vehicle control system includes a steering component configured for controlling axial translation of the wheel assembly to thereby steer the wheel assembly across the surface. The vehicle control system also includes a suspension component configured for controlling vertical translation of the wheel assembly with respect to the surface. The vehicle also includes a fairing assembly configured for reducing aerodynamic drag across the wheel assembly and including the first portion, the second portion removably coupled to the first portion, and a fastener configured for attaching the first portion to the vehicle control system. The fairing assembly allows for full rotation of the wheel assembly about the axle and is moveable in unison with the wheel assembly during vehicle steering and suspension maneuvers.

A fairing assembly configured for reducing aerodynamic drag across a wheel assembly of a vehicle including at least one of a steering component and a suspension component attached to the wheel assembly includes a first portion and a second portion. The first portion is configured for partially enclosing an inboard surface of the wheel assembly and defines an aperture configured for receiving at least one of the steering component and the suspension component. The first portion is attachable to at least one of the steering component and the suspension component. The second portion of the fairing assembly is configured for partially enclosing an outboard surface of the wheel assembly and has an aerodynamic outboard surface. The second portion is removably coupled to the first portion to form a concave shell.

The vehicles of the present invention have reduced aerodynamic drag as compared to vehicles free from the fairing assemblies. That is, the fairing assemblies of the present invention reduce aerodynamic drag across wheel assemblies of vehicles. The fairing assemblies move in unison with the wheel assemblies during steering and suspension maneuvers, such as vehicle turns and dampening of vehicle oscillations in response to travel over an uneven surface, and as such, do not interfere with vehicle steering and/or suspension. Additionally, the fairing assemblies are removable from the vehicle and therefore allow access to the wheel assemblies during maintenance and/or tire changes. The fairing assemblies are scalable for multiple wheel assembly dimensions and are customizable to accommodate existing vehicle steering and suspension components. As such, the fairing assemblies are compatible with multiple vehicle styles. Finally, the fairing assemblies may be suitable for front wheel assemblies and therefore may reduce aerodynamic drag between, e.g., a front fascia and a side body panel of the vehicle. Consequently, the fairing assemblies may be useful for vehicles requiring excellent fuel economy.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a vehicle including a fairing assembly configured for reducing aerodynamic drag across a wheel assembly of the vehicle;

FIG. 2 is a perspective view of the fairing assembly of FIG. 1 attached to a vehicle control system and including a first portion removably coupled to a second portion;

FIG. 3 is a perspective view of the second portion of the fairing assembly of FIG. 2 removed from the first portion of the fairing assembly to reveal an outboard surface of the wheel assembly; and

FIG. 4 is a perspective view of an aerodynamic outboard surface of the fairing assembly of FIG. 1 disposed outboard of a fascia and a side panel of the vehicle of FIG. 1.

### DESCRIPTION OF THE PREFERRED EMBODIMENTS

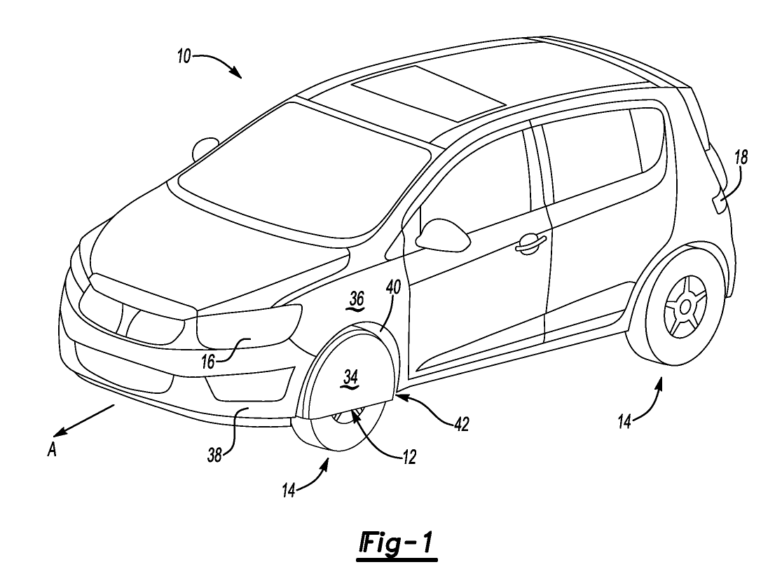

Referring to the drawings, wherein like reference numerals refer to like components, a vehicle having reduced aerodynamic drag is shown generally at 10 in FIG. 1. In particular, the vehicle 10 includes a fairing assembly 12 configured for reducing aerodynamic drag across a wheel assembly 14 of the vehicle 10, as set forth in more detail below. The vehicle 10 and fairing assembly 12 may be useful for automotive applications requiring excellent vehicle fuel economy, such as hybrid vehicles, electric vehicles, and the like. However, the vehicle 10 and fairing assembly 12 may also be useful for non-automotive applications, such as, but not limited to, rail and recreational vehicle applications.

By way of background explanation and with reference to FIG. 1, the vehicle 10 generally travels forward in the direction of arrow A. Therefore, referring to FIG. 1, as used herein, the terminology “front” refers to systems and components disposed relatively closer to the headlights 16 of the vehicle 10. By comparison, the terminology “rear” refers to systems and components disposed relatively closer to the taillights 18 of the vehicle 10. Further, the terminology “outboard” refers to elements disposed relatively towards and/or facing an exterior of the vehicle 10. And, the terminology “inboard” refers to elements disposed relatively towards and/or facing an interior of the vehicle 10.

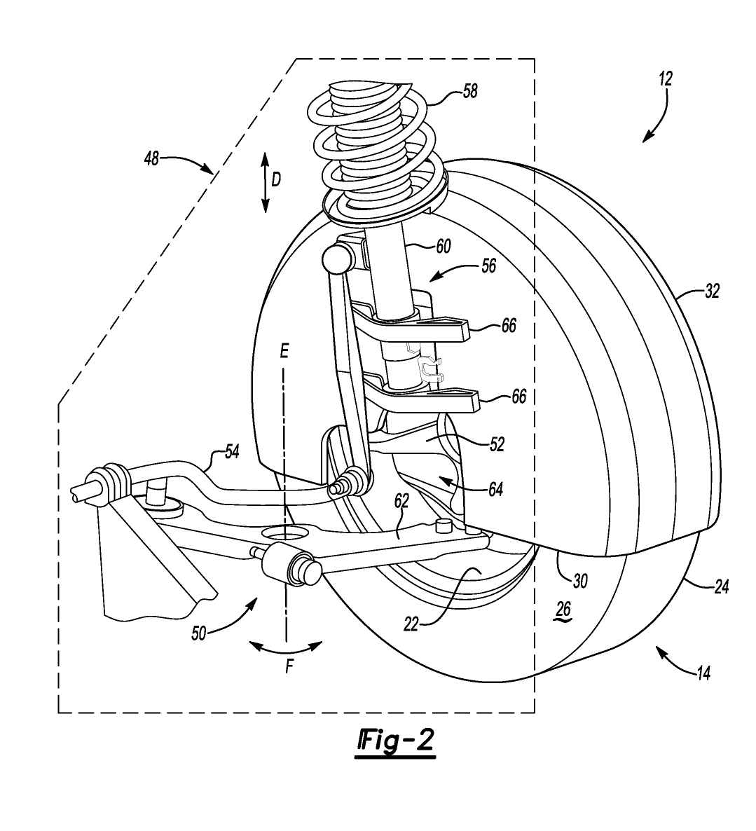

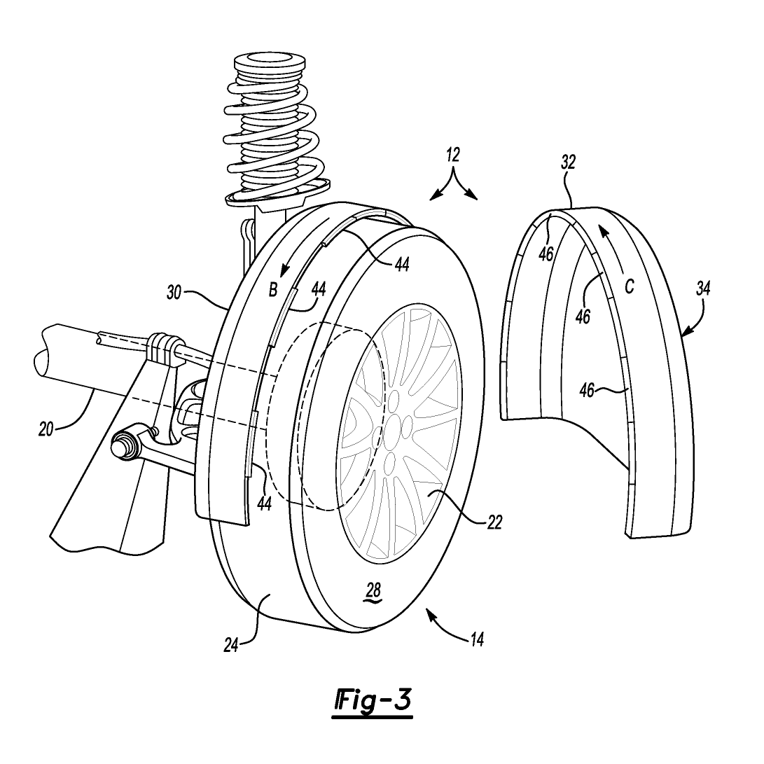

Referring now to FIGS. 1-3, the vehicle 10 includes the wheel assembly 14 that may be disposed on an axle 20 (FIG. 3) of the vehicle 10. The wheel assembly 14 is configured for moving the vehicle 10 across a surface (not shown), e.g., a road, and has an inboard surface 26 (FIG. 2) and an outboard surface 28 (FIG. 3). That is, referring to FIG. 3, the wheel assembly 14 includes a wheel 22 configured for rotation with respect to the vehicle 10 and a tire 24 disposed on the wheel 22. In operation, the axle 20 is turned by, e.g., a driveshaft (not shown) of the vehicle 10, which in turn rotates the wheel 22 of the vehicle 10. The wheel 22 may be a front wheel, i.e., disposed on a front axle of the vehicle 10. Therefore, the fairing assembly 12 may be useful for reducing aerodynamic drag across steerable wheels, i.e., front wheels, as shown in FIG. 1. However, although not shown in FIG. 1, it is also to be appreciated that the fairing assembly 12 may be useful for rear wheels, for vehicle applications including steerable rear wheels.

Referring to FIGS. 1 and 2, the vehicle 10 also includes the fairing assembly 12 configured for reducing aerodynamic drag across the wheel assembly 14. As shown in FIG. 2, the fairing assembly 12 includes a first portion 30 configured for partially enclosing the inboard surface 26 of the wheel assembly 14. That is, the first portion 30 may have a semi-circular shape that is configured for enclosing a top portion of the inboard surface 26 of the wheel assembly 14. Although shown in FIG. 2 as enclosing about half of the inboard surface 26 of the wheel assembly 14, the first portion 30 may alternatively enclose more than or less than about half of the inboard surface 26 of the wheel assembly 14. Therefore, in operation, the wheel assembly 14 may still contact the surface (not shown), e.g., a driving surface such as a road, without interference from the fairing assembly 12.

Referring to FIG. 2, the fairing assembly 12 may be attached to the vehicle 10 via the first portion 30. The first portion 30 may be attached to the vehicle via any suitable attachment method or device, as set forth in more detail below. For example, the first portion 30 may be attached to the vehicle 10 via straps, brackets, snaps, adhesives, sleeves, channels, screws, bolts, bands, rivets, an interference fit, and combinations thereof. In another variation, the first portion 30 may be integral with another component of the vehicle 10, e.g., the axle 20 (FIG. 3).

Referring now to FIGS. 2 and 3, the fairing assembly 12 includes a second portion 32 configured for partially enclosing the outboard surface 28 (FIG. 3) of the wheel assembly 14. That is, the second portion 32 may also have a semi-circular shape that is configured for enclosing a top portion of the outboard surface 28 of the wheel assembly 14. Further, although shown in FIG. 3 as enclosing about half of the outboard surface 28 of the wheel assembly 14, the second portion 32 may alternatively enclose more than or less than about half of the outboard surface 28 of the wheel assembly 14. Moreover, the second portion 32 may partially enclose a portion of the outboard surface 28 of the wheel assembly 14 that is equal to, more than, or less than the partially enclosed portion of the inboard surface 26 of the wheel assembly 14. That is, the first portion 30 and the second portion 32 of the fairing assembly 12 may have the same or different shape.

The second portion 32 may have an aerodynamic outboard surface 34, best shown in FIG. 1, configured for reducing aerodynamic drag across the wheel assembly 14. For example, as shown in FIG. 1, the vehicle 10 may further include a side body panel 36 and a fascia 38 spaced apart from the side body panel 36 to define a wheelhouse 40 configured for housing the wheel assembly 14. The fascia 38 may be for example, a front fascia and/or bumper, or a rear fascia and/or bumper of the vehicle 10. Similarly, the side body panel 36 may be a front or rear side body panel. The wheel assembly 14 may be housed within the wheelhouse 40 according to vehicle styling and to provide protection of the wheel assembly 14.

Referring to FIG. 1, the aerodynamic outboard surface 34 of the second portion 32 may be disposed on the vehicle 10 so as to maintain a substantially uninterrupted air flow across the wheelhouse 40 from the fascia 38 to the side body panel 36. Therefore, the aerodynamic outboard surface 34 may be shaped, i.e., “tuned”, so as to closely match the body styling and curvature of the vehicle 10 to provide for the substantially uninterrupted air flow. For example, referring to FIG. 1, the aerodynamic outboard surface 34 may be sized and shaped so as to minimize any gaps 42 between the fairing assembly 12 and the side body panel 36 and fascia 38, and/or between the fairing assembly 12 and underside (not shown) of the vehicle 10.

Referring to FIG. 1, in one variation, the aerodynamic outboard surface 34 of the second portion 32 may be disposed in the same plane as, i.e., flush with, at least one of the fascia 38 and the side body panel 36 of the vehicle 10. That is, the aerodynamic outboard surface 34 may be disposed in the same plane as the fascia 38 and/or the side body panel 36 to as to provide a smooth transition between the fascia 38 and the side body panel 36 across the wheelhouse 40.

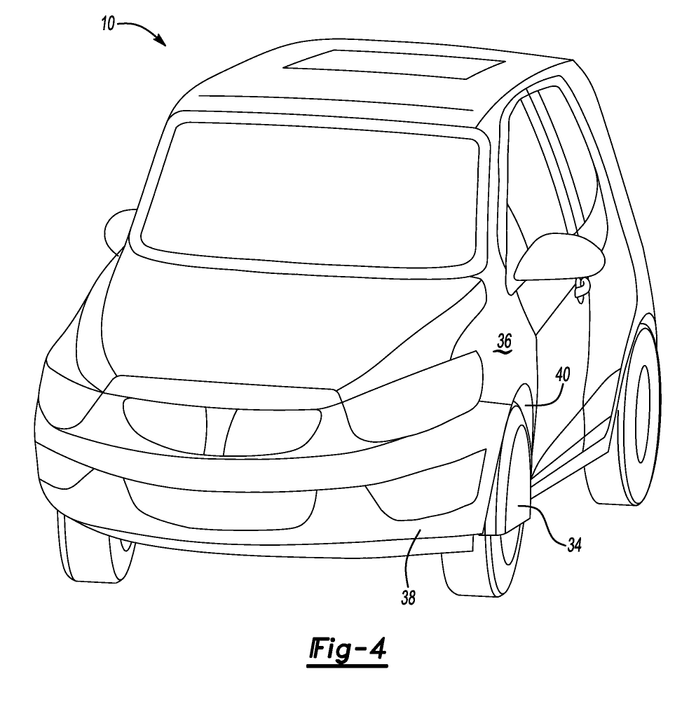

Referring to FIG. 4, in another variation, the aerodynamic outboard surface 34 may be disposed outboard of at least one of the fascia 38 and the side body panel 36 of the vehicle 10. That is, depending on vehicle styling, the aerodynamic outboard surface 34 may be disposed in a plane outboard of and parallel to the plane of the side body panel 36 and/or fascia 38 to redirect airflow across the wheelhouse 40. Additionally, although not shown, the aerodynamic outboard surface 34 may also be disposed slightly inboard of the plane of the fascia 38 and/or the side body panel 36.

Referring to FIGS. 2 and 3, the second portion 32 is removably coupled to the first portion 30. That is, in operation on the vehicle 10, the second portion 32 may be coupled to the first portion 30, as shown in FIG. 2 and set forth in more detail below. However, to provide access to the wheel assembly 14, for example, during a tire change or maintenance, the second portion 32 may be removed from the first portion 30, as shown in FIG. 3, and also set forth in more detail below. Stated differently, the fairing assembly 12 may form a concave shell configured for partially enclosing the wheel assembly 14 when the first portion 30 is removably coupled to the second portion 32.

Referring now to FIG. 3, the first portion 30 and the second portion 32 may be removably coupled via any suitable method and/or device. For example, the first portion 30 may be removably coupled to the second portion 32 via snaps, straps, buckles, bolts, screws, brackets, hook-and-look fasteners, an interference fit, flanges, and combinations thereof, etc. In one example, the first portion 30 and the second portion 32 may be removably coupled via a corresponding flange 44 and slot 46. That is, the flange 44 may extend from the first portion 30 and may be configured for mating with the second portion 32 of the fairing assembly 12. More specifically, the slot 46 may be defined by the second portion 32 and may be configured for receiving and retaining the flange 44. For example, the flange 44 may have a T-shape and may insert and lock within the slot 46 when the second portion 32 is rotated with respect to the first portion 30, e.g., in a counterclockwise direction as indicated by arrow B in FIG. 3. When the flange 44 is inserted into the slot 46, the second portion 32 is retained by the flange 44 against the first portion 30. Similarly, the second portion 32 may be removable from the first portion 30 via rotation of the second portion 32 with respect to the first portion 30, e.g., in a clockwise direction as indicated by arrow C in FIG. 3. Further, referring to FIG. 3, it is to also be appreciated that the fairing assembly 12 may include a plurality of flanges 44 and/or slots 46.

Referring generally to FIGS. 1-4, the fairing assembly 12 is movable in unison with the wheel assembly 14 during vehicle steering and suspension maneuvers. That is, although the wheel assembly 14 may still rotate about the axle 20 with respect to the fairing assembly 12, the fairing assembly 12 may not be vertically or axially translatable relative to the wheel assembly 14. Stated differently, there may be no relative vertical or axial movement of the fairing assembly 12 with respect to the wheel assembly 14, and the fairing assembly 12 may not move independently with respect to the wheel assembly 14.

More specifically, referring to FIG. 2, the fairing assembly 12 may be vertically translatable, for example in a direction indicated by arrow D, in unison with the wheel assembly 14 during vehicle suspension maneuvers. As known in the art, vehicle suspension maneuvers may include oscillation dampening of the vehicle 10 in response to, for example, an uneven road surface. As the wheel assembly 14 travels over a bump or an uneven road surface, the fairing assembly 12 may translate vertically in unison with the wheel assembly 14. Therefore, the wheel assembly 14 does not contact the fairing assembly 12 during suspension maneuvers, and the wheel assembly 14 may still contact the road surface (not shown) without interference from the fairing assembly 12.

Likewise, the fairing assembly 12 may be axially translatable, e.g., pivotable about axis E in a direction indicated by arrow F in FIG. 2, in unison with the wheel assembly 14 during vehicle steering maneuvers. As known in the art, vehicle steering maneuvers may include pivoting the axle 20 (FIG. 3) and the wheel assembly 14 with respect to the side body panel 36 (FIG. 1) of the vehicle 10 so as to steer the wheel assembly 14 and vehicle 10. As the wheel assembly 14 is steered along the road surface (not shown), the fairing assembly 12 may axially translate in unison with the wheel assembly 14. Therefore, the wheel assembly 14 does not contact the fairing assembly 12 during steering maneuvers, and the wheel assembly 14 may still contact the road surface (not shown) without interference from the fairing assembly 12.

The fairing assembly 12 may be formed from any suitable material capable of withstanding an operating environment of the vehicle 10. For example, the fairing assembly 12 may be formed from metal and/or a polyurethane.

Referring now to FIG. 2, the vehicle 10 may include a vehicle control system 48 attached to the wheel 22 and partially disposed within the wheelhouse 40 (FIG. 1). More specifically, referring to FIG. 2, the vehicle control system 48 includes a steering component 50 configured for controlling axial translation of the wheel assembly 14 to thereby steer the wheel assembly 14 across the surface (not shown). The steering component 50 may include a plurality of elements, such as, but not limited to, a steering knuckle 52 and a steering linkage 54.

As shown in FIG. 2, the vehicle control system 48 of the vehicle 10 also includes a suspension component 56 configured for controlling vertical translation of the wheel assembly 14 with respect to the surface (not shown). The suspension component 56 may include a plurality of elements, such as, but not limited to, a shock absorber 58, a strut 60, and a control arm 62.

Referring again to FIG. 2, the first portion 30 of the fairing assembly 12 may define an aperture 64 that is configured for receiving at least one of the steering component 50 and the suspension component 56. That is, the first portion 30 may be shaped to accommodate existing vehicle components. For example, the aperture 64 may accommodate a component of the vehicle control system 48, such as, but not limited to, the strut 60, the steering knuckle 52, and/or the control arm 62. Therefore, the aperture 64 may have any shape and/or size according to desired vehicle design and component configuration. Further, although not shown in FIG. 2, the first portion 30 may also include additional cut-outs, i.e., openings, to prevent debris build-up, allow for venting, ease of installation, and/or maintenance of other vehicle components.

Additionally, as shown in FIG. 2, the fairing assembly 12 may include a fastener 66 configured for attaching the first portion 30 to the vehicle control system 48. That is, the fastener 66 may be attached to at least one of the steering component 50 and the suspension component 56. Therefore, in operation, the fastener 66 may attach the first portion 30 to at least one of the steering component 50 and the suspension component 56.

Any suitable fastener 66, such as, but not limited to, straps, brackets, snaps, adhesives, sleeves, channels, screws, bolts, bands, rivets, interference fit surfaces, and combinations thereof, may attach the first portion 30 to the vehicle control system 48. In one example, as shown in FIG. 2, the fastener 66 may be a bracket. In another variation, the fastener 66 may be a plurality of brackets each configured for attachment to the vehicle 10. The brackets may, for example, surround the strut 60 of the suspension component 56 and be bolted to the first portion 30 of the fairing assembly 12.

The fairing assembly 12 allows for full rotation of the wheel assembly 14 about the axle 20 (FIG. 3) and is moveable in unison with the wheel assembly 14 during vehicle steering and suspension maneuvers, as set forth above. Referring again to FIGS. 1-4, the fairing assembly 12 configured for reducing aerodynamic drag across the wheel assembly 14 of the vehicle 10 (FIGS. 1 and 4) including at least one of the steering component 50 and the suspension component 56 attached to the wheel assembly 14 includes the first portion 30 and the second portion 32. Referring to FIG. 2, the first portion 30 is configured for partially enclosing the inboard surface 26 of the wheel assembly 14 and defines the aperture 64 configured for receiving at least one of the steering component 50 and the suspension component 56. The first portion 30 is attachable to at least one of the steering component 50 and the suspension component 56. The second portion 32 is configured for partially enclosing the outboard surface 28 (FIG. 3) of the wheel assembly 14 and has the aerodynamic outboard surface 34 (FIGS. 1, 3, and 4). The second portion 32 is removably coupled to the first portion 30 to form a concave shell.

The vehicles 10 of the present invention have reduced aerodynamic drag as compared to vehicles free from the fairing assemblies 12. That is, the fairing assemblies 12 reduce aerodynamic drag across wheel assemblies 14 of vehicles 10. The fairing assemblies 12 move in unison with the wheel assemblies 14 during steering and suspension maneuvers, such as vehicle turns and dampening of vehicle oscillations in response to travel over an uneven surface, and as such, do not interfere with vehicle steering and/or suspension. Additionally, the fairing assemblies 12 are removable from the vehicle 10 and therefore allow access to the wheel assemblies 14 during maintenance and/or tire changes. The fairing assemblies 12 are scalable for multiple wheel assembly dimensions and are customizable to accommodate existing vehicle steering and suspension components 50, 56. As such, the fairing assemblies 12 are compatible with multiple vehicle styles. Finally, the fairing assemblies 12 may be suitable for front wheel assemblies 14 and therefore may reduce aerodynamic drag between, e.g., a front fascia 38 and a side body panel 36 of the vehicle 10. Consequently, the fairing assemblies 12 may be useful for vehicles 10 requiring excellent fuel economy.

While the best modes for carrying out the invention have been described in detail, those familiar with the art to which this invention relates will recognize various alternative designs and embodiments for practicing the invention within the scope of the appended claims.

1. A vehicle having reduced aerodynamic drag comprising:
a wheel assembly configured for moving the vehicle across a surface, said wheel assembly having an inboard surface and an outboard surface and including a wheel configured for rotation with respect to the vehicle and a tire disposed on said wheel; and
a fairing assembly configured for reducing aerodynamic drag across said wheel assembly and including;
a first portion configured for partially enclosing said inboard surface of said wheel assembly; and
a second portion configured for partially enclosing said outboard surface of said wheel assembly and removably coupled to said first portion;
wherein said fairing assembly is moveable in unison with said wheel assembly during vehicle steering and suspension maneuvers.

2. The vehicle of claim 1, wherein said fairing assembly is not vertically or axially translatable relative to said wheel assembly.

3. The vehicle of claim 1, wherein said fairing assembly is vertically translatable in unison with said wheel assembly during vehicle suspension maneuvers.

4. The vehicle of claim 3, wherein said fairing assembly is axially translatable in unison with said wheel assembly during vehicle steering maneuvers.

5. The vehicle of claim 1, wherein said fairing assembly forms a concave shell configured for partially enclosing said wheel assembly when said first portion is removably coupled to said second portion.

6. The vehicle of claim 1, wherein said second portion has an aerodynamic outboard surface configured for reducing aerodynamic drag across said wheel assembly.

7. The vehicle of claim 6, further including a side body panel and a fascia spaced apart from said side body panel to define a wheelhouse configured for housing said wheel assembly, wherein said aerodynamic outboard surface is disposed in the same plane as at least one of said fascia and said side body panel of the vehicle.

8. The vehicle of claim 6, further including a side body panel and a fascia spaced apart from said side body panel to define a wheelhouse configured for housing said wheel assembly, wherein said aerodynamic outboard surface is disposed outboard of at least one of said fascia and said side body panel of the vehicle.

9. The vehicle of claim 1, wherein said first portion and said second portion are removably coupled via a corresponding flange and slot.

10. The vehicle of claim 9, wherein said flange extends from said first portion and is configured for mating with said second portion.

11. The vehicle of claim 10, wherein said slot is defined by said second portion and is configured for receiving and retaining said flange.

12. The vehicle of claim 1, wherein said second portion is removable from said first portion via rotation of said second portion with respect to said first portion.

13. The vehicle of claim 1, wherein said wheel is a front wheel of the vehicle.

14. A vehicle having reduced aerodynamic drag comprising:
an axle;
a wheel assembly disposed on said axle, said wheel assembly having an inboard surface and an outboard surface and including a wheel configured for rotation with respect to the vehicle and a tire disposed on said wheel;
a side body panel;
a fascia spaced apart from said side body panel to define a wheelhouse that is configured for housing said wheel assembly;
a vehicle control system attached to said wheel and partially disposed within said wheelhouse, said vehicle control system including;
a steering component configured for controlling axial translation of said wheel assembly to thereby steer said wheel assembly across a surface; and
a suspension component configured for controlling vertical translation of said wheel assembly with respect to the surface; and
a fairing assembly configured for reducing aerodynamic drag across said wheel assembly and including;
a first portion configured for partially enclosing said inboard surface of said wheel assembly;
a second portion configured for partially enclosing said outboard surface of said wheel assembly and removably coupled to said first portion; and
a fastener configured for attaching said first portion to said vehicle control system;
wherein said fairing assembly allows for full rotation of said wheel assembly about said axle and is moveable in unison with said wheel assembly during vehicle steering and suspension maneuvers.

15. The vehicle of claim 14, wherein said first portion defines an aperture that is configured for receiving at least one of said steering component and said suspension component.

16. The vehicle of claim 14, wherein said fastener is attached to at least one of said steering component and said suspension component.

17. The vehicle of claim 14, wherein said fastener is a bracket.

18. A fairing assembly configured for reducing aerodynamic drag across a wheel assembly of a vehicle including at least one of a steering component and a suspension component attached to the wheel assembly, the fairing assembly comprising:
a first portion configured for partially enclosing an inboard surface of the wheel assembly and defining an aperture configured for receiving at least one of the steering component and the suspension component;
wherein said first portion is attachable to at least one of the steering component and the suspension component; and
a second portion configured for partially enclosing an outboard surface of the wheel assembly and having an aerodynamic outboard surface;
wherein said second portion is removably coupled to said first portion to form a concave shell.

19. The fairing assembly of claim 18, further including a fastener configured for attaching said first portion to at least one of the steering component and the suspension component.

20. The fairing assembly of claim 18, wherein said first portion and said second portion are removably coupled via a corresponding flange and slot.
